(19) United States
(12) Patent Application Publication
(10) Pub. No.: US 2024/0255454 A1
(43) Pub. Date: Aug. 1, 2024

(54) UTILIZING THERMAL CAMERA FOR DETECTING SCALE IN PIPELINES

(71) Applicant: SAUDI ARABIAN OIL COMPANY, Dhahran (SA)

(72) Inventor: Mamdouh Hassan Hadi, Dhahran (SA)

(73) Assignee: SAUDI ARABIAN OIL COMPANY, Dhahran (SA)

(21) Appl. No.: 18/163,122

(22) Filed: Feb. 1, 2023

(51) Int. Cl. G01N 25/72; F17D 5/00

(52) U.S. Cl. CPC G01N 25/72; F17D 5/00

(57) ABSTRACT

A method for detecting a scaled area of a pipeline is disclosed. The method includes scanning, using a thermal camera, a surface area of the pipeline in an offline status to determine that surface temperature is within a pre-determined range of ambient temperature, starting up fluid flow of the pipeline upon determination that the surface temperature is within the pre-determined range, further scanning, using the thermal camera and subsequent to starting up the fluid flow, the surface area of the pipeline to determine that at least one location of the surface area, and not an entirety of the surface area, is within a pre-determined range of an operating surface temperature of the pipeline, detecting, in response to the further scanning, a low temperature portion of the surface area, and classifying the lower temperature portion of the surface area as a scaled area.

### BACKGROUND

Oil and gas facilities require frequent inspection in order to ensure integrity of pipeline structures and safe work practices. On-stream inspection (OSI) is performed on equipment and piping, such as a pressure vessel, while it is on-stream (i.e., in service or online) to establish the suitability of the pressure boundary for continued operation. Scale is a common term in the oil industry to describe solid deposits that grow over time, blocking and hindering fluid flow through pipelines, valves, pumps etc. Scaling (i.e., progression of scale) is a major challenge among pipelines networks that negatively impacts the production operations and usually leads to production losses. One practice to identify scale locations involves performing random cuts on scattered locations of any affected pipeline until the scaled portion is observed. This practice is very costly, time consuming and requires tremendous efforts to complete the inspection of one pipeline, it also leads to significant production losses in some cases due to the multiple unnecessary cutting and welding activities. Efficient and cost effective techniques have not been available to identify exact scale locations on pipelines thus causing delays in pipelines restoration.

### SUMMARY

In general, in one aspect, the invention relates to a method for detecting a scaled area of a pipeline in an oil and gas facility. The method includes scanning, using a thermal camera, a surface area of the pipeline in an offline status to determine that surface temperature across the surface area is within a pre-determined range of ambient temperature, starting up fluid flow of the pipeline upon determination that the surface temperature across the surface area is within the pre-determined range of the ambient temperature, further scanning, using the thermal camera and subsequent to starting up the fluid flow, the surface area of the pipeline to determine that at least one location of the surface area, and not an entirety of the surface area, is within a pre-determined range of an operating surface temperature of the pipeline, detecting, in response to the further scanning, a low temperature portion of the surface area, and classifying the lower temperature portion of the surface area as a scaled area.

In general, in one aspect, the invention relates to a system for detecting a scaled area of a pipeline in an oil and gas facility. The system includes a thermal camera configured to scan a surface area of the pipeline in an offline status to determine a surface temperature across the surface area is within a pre-determined range of ambient temperature, wherein fluid flow of the pipeline is started up subsequent to the determination, and further scan, subsequent to starting up the fluid flow, the surface area of the pipeline to determine that at least one location of the surface area, and not an entirety of the surface area, is within a pre-determined range of an operating surface temperature of the pipeline, and a data gathering and analysis system configured to detect, in response to said further scanning, a low temperature portion of the surface area as a scaled area.

Other aspects and advantages will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1A-1E show a system in accordance with one or more embodiments.

FIG. 2 shows a flowchart in accordance with one or more embodiments.

FIGS. 3A-3C show an example in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Embodiments of the invention provide a method and a system that utilize a thermal camera to conduct thermal scanning of the pipeline surface temperature while the pipeline is put on-stream in order to identify the scale locations. During the initial period to become fully on-stream, stream fluid transfers heat to the pipeline causing the pipeline surface temperature to gradually rise. A considerable difference in the thermal conductivity exists between metallic pipelines and scales. This difference in thermal conductivity results in a lower pipeline surface temperature at scaled portions during the initial on-stream period before thermal equilibrium is achieved. By conducting thermal scanning using the thermal camera during this initial on-stream period, low temperature is identified on the pipeline surface, which represents the scaled portions that need to be treated. Pipeline surface temperature difference between the scaled portions and scale-free portions is dependent on the scale volume. Hence, large scale volume results in a correspondingly higher surface temperature difference. This higher surface temperature difference enhances the accuracy of scale detection and corresponds to an approximately quantifiable scale volume.

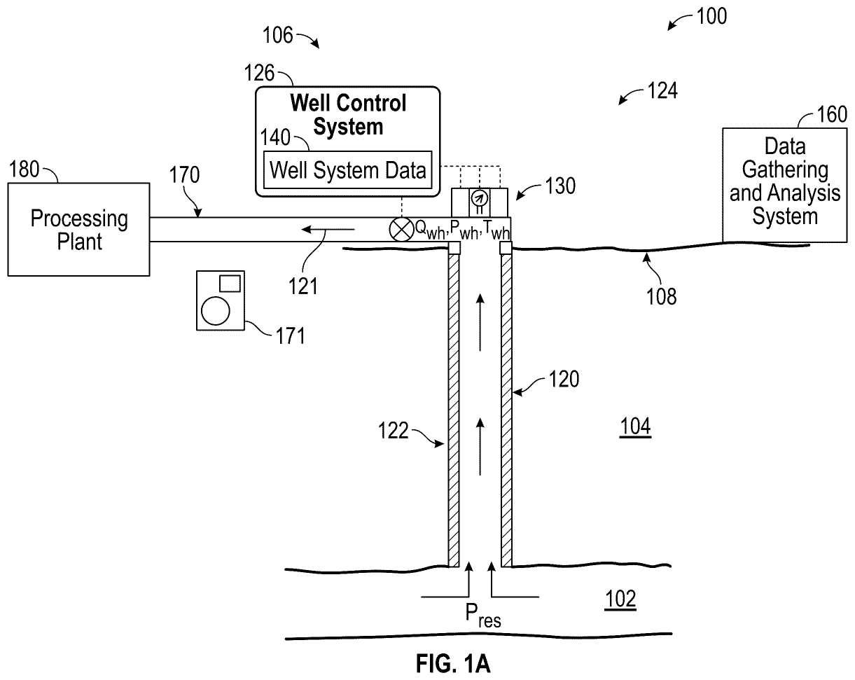

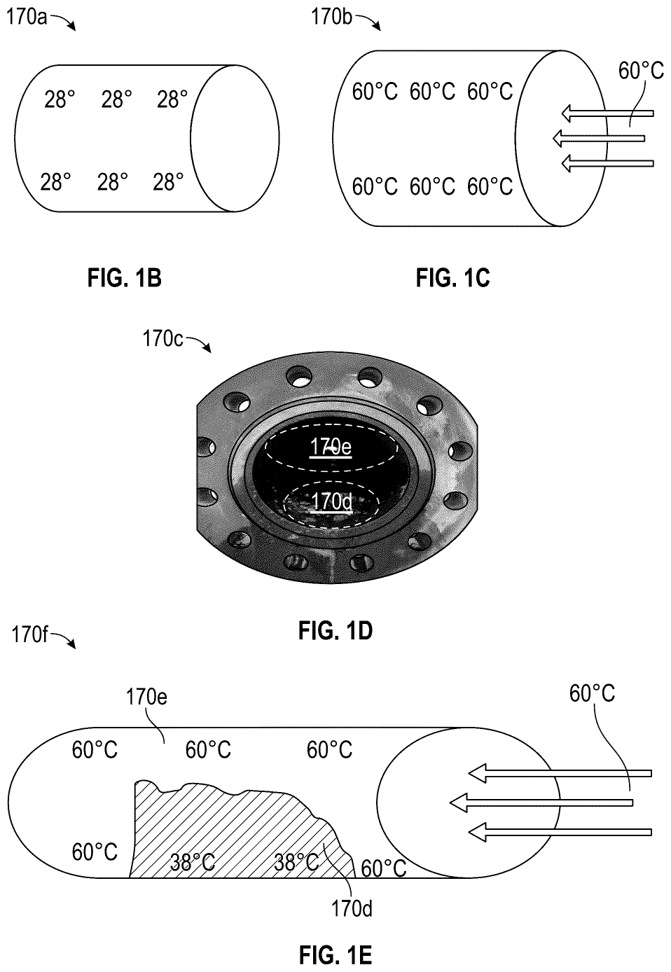

Turning to FIG. 1A, FIG. 1A shows a schematic diagram of an oil and gas facility in accordance with one or more embodiments. As shown in FIG. 1A, FIG. 1A illustrates a well environment (100) that includes a hydrocarbon reservoir (“reservoir”) (102) located in a subsurface hydrocarbon-bearing formation (“formation”) (104) and a well system (106). The hydrocarbon-bearing formation (104) may include a porous or fractured rock formation that resides underground, beneath the earth's surface (“surface”) (108). In the case of the well system (106) being a hydrocarbon well, the reservoir (102) may include a portion of the hydrocarbon-bearing formation (104). The hydrocarbon-bearing formation (104) and the reservoir (102) may include different layers of rock having varying characteristics, such as varying degrees of permeability, porosity, capillary pressure, and resistivity. In the case of the well system (106) being operated as a production well, the well system (106) may facilitate the extraction of hydrocarbons (or “production”) from the reservoir (102). The well system (106) may be part of a production system that further includes a pipeline network (170) and a processing plant (180) for transporting and processing the hydrocarbons, i.e., production from the reservoir (102). In some embodiments, a thermal camera (171) is provided to facilitate operations of the production system, such as a maintenance operation. The thermal camera (171) is an imaging device that captures and creates an image of an object by using infrared radiation emitted from the object in a process referred to as thermal imaging. The created image represents the temperature of the object. For example, the thermal camera image may represent different temperatures across the object (e.g., a pipeline of the production system) using different colors or brightness in the created image.

In some embodiments, the well system (106) includes a wellbore (120), a well sub-surface system (122), a well surface system (124), and a well control system (“control system”) (126). The control system (126) may control various operations of the well system (106), such as well production operations, well completion operations, well maintenance operations, and reservoir monitoring, assessment and development operations. In some embodiments, the control system (126) includes a computer system.

The wellbore (120) may include a bored hole that extends from the surface (108) into a target zone of the hydrocarbon-bearing formation (104), such as the reservoir (102). An upper end of the wellbore (120), terminating at or near the surface (108), may be referred to as the “up-hole” end of the wellbore (120), and a lower end of the wellbore, terminating in the hydrocarbon-bearing formation (104), may be referred to as the “down-hole” end of the wellbore (120). The wellbore (120) may facilitate the circulation of drilling fluids during drilling operations, the flow of hydrocarbon production (“production”) (121) (e.g., oil and gas) from the reservoir (102) to the surface (108) during production operations, the injection of substances (e.g., water) into the hydrocarbon-bearing formation (104) or the reservoir (102) during injection operations, or the communication of monitoring devices (e.g., logging tools) into the hydrocarbon-bearing formation (104) or the reservoir (102) during monitoring operations (e.g., during in situ logging operations).

In some embodiments, during operation of the well system (106), the control system (126) collects and records well system data (140) for the well system (106). The well system data (140) may include, for example, a record of measurements of wellhead pressure (P_{wh}) (e.g., including flowing wellhead pressure), wellhead temperature (T_{wh}) (e.g., including flowing wellhead temperature), wellhead production rate (Q_{wh}) over some or all of the life of the well (106), and water cut data. The well system data (140) may further include monitoring data of pipeline structures at the wellsite such as thermal camera scanning data obtained by a thermal camera. The thermal camera scanning data may include images of pipelines captured using infrared radiation emitted from the pipelines that represents the temperature of the pipeline surface. The thermal camera scanning data may further include location data (e.g., global positioning system (GPS) data) of the captured images. In some embodiments, the measurements and monitoring data are recorded in real-time, and are available for review or use within seconds, minutes or hours of the condition being sensed (e.g., the measurements are available within 1 hour of the condition being sensed). In such an embodiment, the well system data (140) may be referred to as “real-time” well system data (140). Real-time well system data (140) may enable an operator of the well (106) to assess a relatively current state of the well system (106), and make real-time decisions regarding development and maintenance of the well system (106) and the reservoir (102), such as on-demand adjustments in regulation of production flow from the well or preventive maintenance of pipeline structures to prevent disruption to the production flow from the well.

In some embodiments, the well sub-surface system (122) includes casing installed in the wellbore (120). For example, the wellbore (120) may have a cased portion and an uncased (or “open-hole”) portion. The cased portion may include a portion of the wellbore having casing (e.g., casing pipe and casing cement) disposed therein.

In some embodiments, the well surface system (124) includes a wellhead (130). The wellhead (130) may include a rigid structure installed at the “up-hole” end of the wellbore (120), at or near where the wellbore (120) terminates at the Earth's surface (108). The wellhead (130) may include structures for supporting (or “hanging”) casing and production tubing extending into the wellbore (120). Production (121) may flow through the wellhead (130), after exiting the wellbore (120) and the well sub-surface system (122), including, for example, the casing and the production tubing.

In some embodiments, the well system (106) includes a data gathering and analysis system (160). For example, the data gathering and analysis system (160) may include hardware and/or software with functionality for facilitating operations of the well system (106), such as well production operations, well drilling operation, well completion operations, well maintenance operations, and reservoir monitoring, assessment and development operations. For example, the data gathering and analysis system (160) may store well system data (140) such as thermal camera scanning data. In some embodiments, the data gathering and analysis system (160) may analyze the thermal camera scanning data to generate recommendations to facilitate various operations of the well system (106), such as a preventive maintenance of the pipeline structures. While the data gathering and analysis system (160) is shown at a wellsite, embodiments are contemplated the data gathering and analysis system (160) is located away from well sites.

While the thermal camera scanning data is described above for pipeline structures installed in the well system (106), additional and/or alternative monitoring data may correspond to pipeline structures installed in the pipeline network (170) and/or the processing plant (180). In one or more embodiments, the processing plant (180) is an industrial process plant such as an oil/petroleum refinery where petroleum (crude oil) is transformed and refined, or other types of chemical processing plant. The processing plant (180) typically includes large, sprawling industrial complexes with extensive piping network running throughout, carrying streams or liquids between large chemical processing units, such as distillation columns.

While the oil and gas facilities are shown as including the well environment (100) and processing plant (180), in one or more embodiments, the oil and gas facilities may additionally or alternatively include equipment (pressure vessels), storage tanks, piping and an associated pipeline network.

Turning to FIGS. 1B-1E, FIGS. 1B-1E show various diagrams in accordance with one or more embodiments. In one or more embodiments, one or more of the modules and/or elements shown in FIGS. 1B-1E may be omitted, repeated, and/or substituted. Accordingly, embodiments of the invention should not be considered limited to the specific arrangements of modules and/or elements shown in FIGS. 1B-1E.

FIGS. 1B-1E illustrates various views of an example section of the pipeline network (170) depicted in FIG. 1A above. The surface temperature readings shown in these views are obtained from thermal camera images of the pipeline. For example, the thermal camera images may be captured using the thermal camera (171) depicted in FIG. 1A above.

FIG. 1B shows the offline view (170a) that illustrates a surface temperature map of the pipeline surface area when the pipeline network (170) is offline without any fluid flow at the operating temperature. For example, the surface temperature is 28 degrees Celsius (i.e., same as the ambient temperature) throughout the surface area that has reached a thermal equilibrium after the pipeline network (170) is shut down.

FIG. 1C shows the online view (170b) that illustrates a surface temperature map of the pipeline surface area when the pipeline network (170) is online (i.e., on-stream) with fluid flow at the operating temperature. For example, the surface temperature is 60 degrees Celsius throughout the surface area that has reached a thermal equilibrium after the pipeline network (170) becomes online. Note that the ambient temperature is 28 degrees Celsius. Because of the thermal equilibrium in the offline view (170a) and the online view (170b), there is no indication based on localized temperature variations whether there is a scaled area in the pipeline.

FIG. 1D shows the disassembled view (170c) that illustrates a scaled area (170d) where substantial solid deposits (e.g., having a thickness exceeding 1 millimeter) accumulate in the interior of the pipeline wall. In contrast, the scale-free area (170e) does not show any substantial solid deposits (e.g., having a thickness between 0 to 1 millimeter). The scaled area (170d) is easily visible in the disassembled view (170c) due to its proximity to the pipeline flange where the pipeline is disassembled. To detect other scaled area away from any pipeline flanges would require physically cutting the pipeline for visual inspection.

FIG. 1E shows the transient view (170f) that illustrates a surface temperature map of the pipeline surface area during a transient time period (e.g., 1 minute, 10 minutes, etc. before the thermal equilibrium is reached between the pipeline and the fluid stream) after the pipeline network (170) is turned on from an offline status to begin or resume operation at the operating temperature. In other words, fluid at the operating temperature starts to flow through the pipeline. The surface pipeline temperature is close to the ambient temperature (e.g., 26 degrees Celsius) before operating the pipeline. Once the pipeline is put on stream, the pipeline surface temperature will rise up because of the heat transfer from the fluid stream flowing through the pipeline. The pipeline surface temperature will be close to the fluid stream temperature (e.g., at 60 degrees Celsius) for the scale-free area (170e). The surface temperature for the scaled area (170d) will be much lower (e.g., at 38 degrees Celsius) than the fluid stream temperature during the transient time period because of the low thermal conductivity of scale.

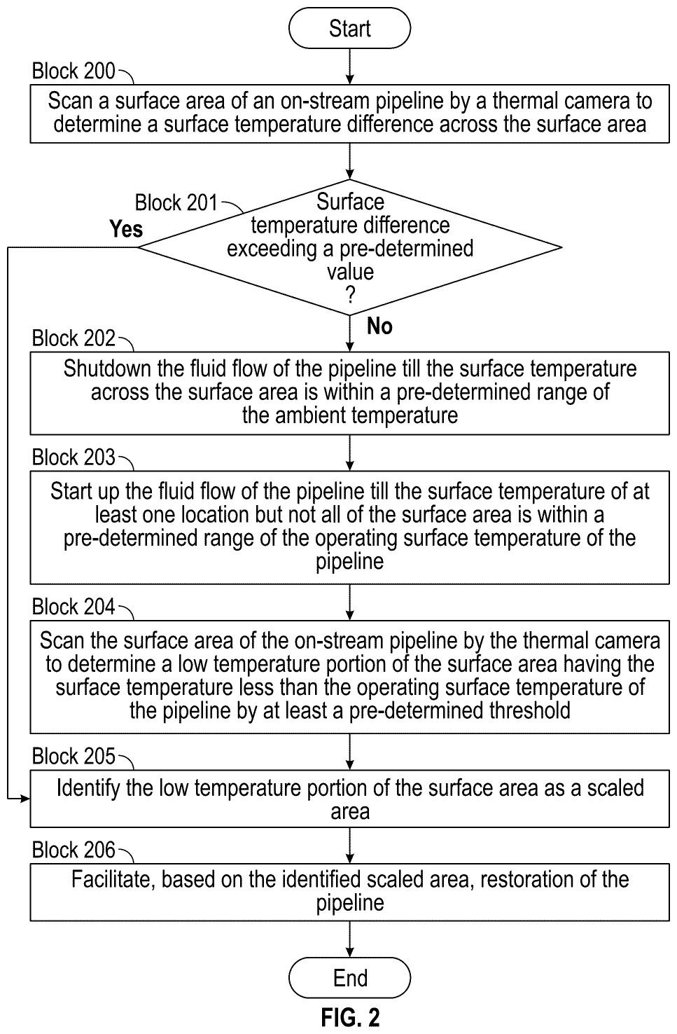

Turning to FIG. 2, FIG. 2 shows a flowchart in accordance with one or more embodiments. Specifically, FIG. 2 describes a method for detecting a scaled area of a pipeline network in an oil and gas facility. One or more blocks in FIG. 2 may be performed using one or more components as described in FIGS. 1A-1B. While the various blocks in FIG. 1A are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

Initially in Block 200, an exterior surface area of an on-stream pipeline is scanned by a thermal camera to determine a surface temperature difference across the surface area. In one or more embodiments, the thermal camera is hand-held by a user moving along the pipeline to perform the scanning. In alternative embodiments, the thermal camera is mounted on a robotic platform that moves along the pipeline to perform the scanning. For example, the thermal camera may be manipulated by hand or by a robotic arm such that the field of view of the thermal camera scans all sides of the pipeline across a length of the pipeline. In one or more embodiments, the continuous video images may be compiled and stitched together based on rotational and linear movement readings from a gyroscopic instrument integrated with the thermal camera. Accordingly, a surface temperature map is generated and stored in a data gathering and analysis system.

In Block 201, a determination is made as to whether the surface temperature difference exceeds a pre-determined value, such as 20 degrees Celsius. If the determination is positive, i.e., the surface temperature difference across the surface area exceeds the pre-determined value, e.g., 20 degrees Celsius, then a determination is made that the pipeline has very severely scale (e.g., near complete blockage) and the method proceeds to Block 205. If the determination is negative, i.e., the surface temperature difference across the surface area does not exceed the pre-determined value, e.g., 20 degrees Celsius, the method proceeds to Block 202.

In Block 202, the fluid flow of the pipeline is shut down and the pipeline is offline (i.e., not operating with fluid flow) until the surface temperature across the surface area is within a pre-determined range of the ambient temperature, e.g., 27 degrees Celsius of air temperature.

In Block 203, the fluid flow of the pipeline is started up again until the surface temperature of at least one location but not all of the surface area is within a pre-determined range of the operating surface temperature of the pipeline, e.g., within 2 degrees of 58 degrees Celsius or between 56-60 degrees Celsius.

In Block 204, while the surface temperature of at least one location, but not all of the surface area of the pipeline, is within a pre-determined range of the operating surface temperature of the pipeline (i.e., prior to thermal equilibrium is reached between the surface area and the fluid stream), the surface area of the once again on-stream pipeline is scanned by the thermal camera to determine a low temperature portion of the surface area having the surface temperature less than the operating surface temperature of the pipeline by at least a pre-determined threshold. The pre-determined threshold may be any suitable degree amount, such as 5 degrees Celsius. For example, the low temperature portion of the surface area may have temperature readings less than 53 degrees Celsius. In one or more embodiments, the re-scanned temperature map is analyzed by the data gathering and analysis system to determine the low temperature portion. In particular, the low temperature portion corresponds to a surface temperature range in the temperature map that is lower than the operating surface temperature by at least the pre-determined threshold.

In Block 205, the low temperature portion of the surface area is identified as a scaled area. In other words, the pipeline wall in the low temperature portion is identified as scaled with solid deposits. In one or more embodiments, the amount (e.g., thickness) of the solid deposits in the low temperature portion of the surface area is estimated based on the amount that the surface temperature is less than the operating surface temperature of the pipeline. For example, the amount (e.g., thickness) of the solid deposits or the extent of the scale may be determined by the data gathering and analysis system based on the re-scanned temperature map. In one or more embodiments, the estimated scale amount may be calibrated by comparing to actual measured scale amount when the low temperature portion of the pipeline is cut open for physical inspection. For example, the comparison or calibration data records may be compiled over a large number of pipeline inspections to use as a machine learning data set. Accordingly, the data gathering and analysis system may improve the accuracy of estimating the amount of scale using machine learning techniques based on the compiled machine learning data set.

In Block 206, restoration of the pipeline is facilitated based on the identified scaled area. For example, a descaling operation of the pipeline having the scaled area may be performed. In another example, a section of the pipeline having the scaled area may be replaced. In one or more embodiments, the restoration operation of the pipeline is performed in response to the estimated scale thickness exceeding a pre-determined scale thickness threshold, such as a pre-determined percentage (e.g., 5%) of an inside diameter of the pipeline.

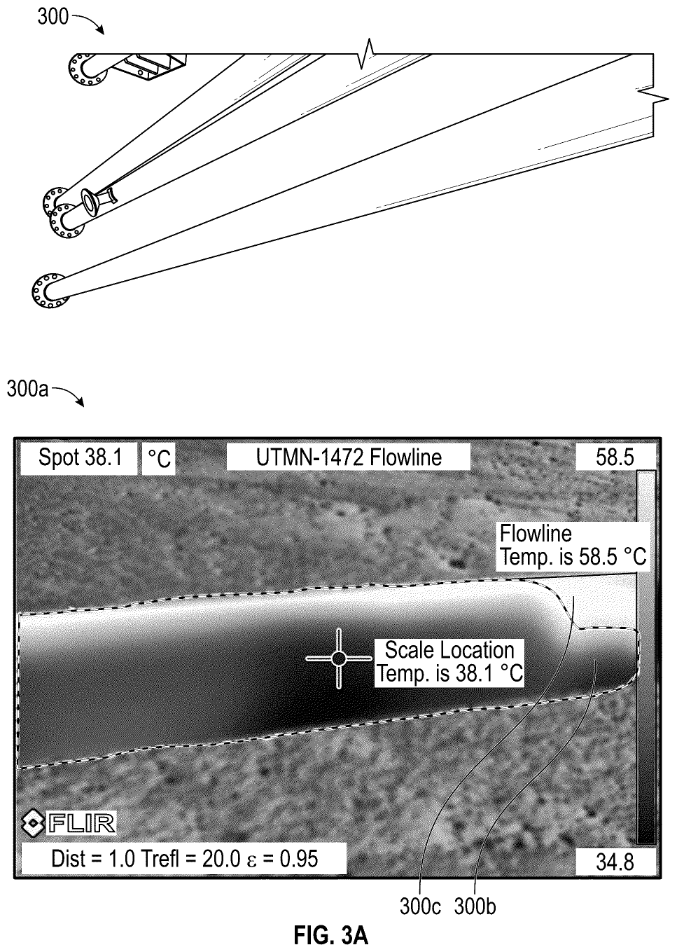

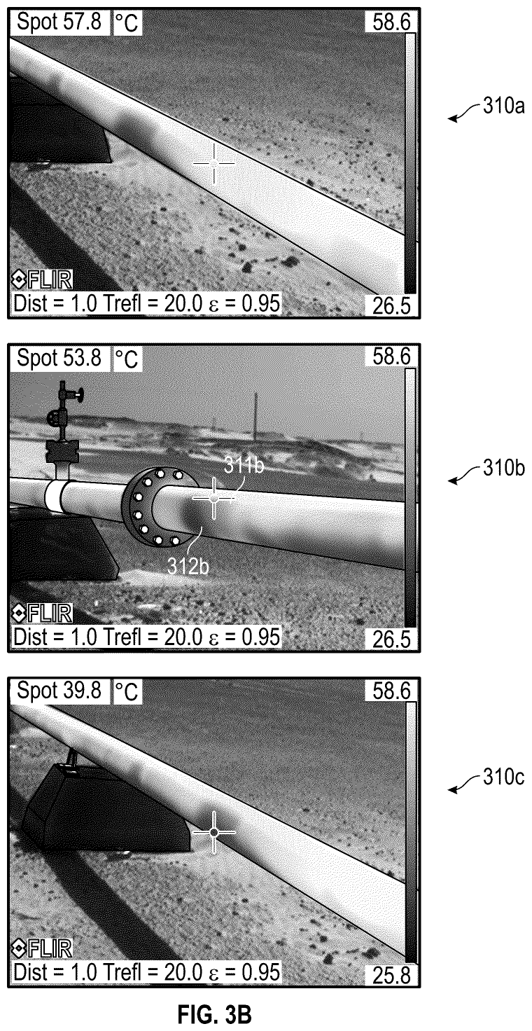

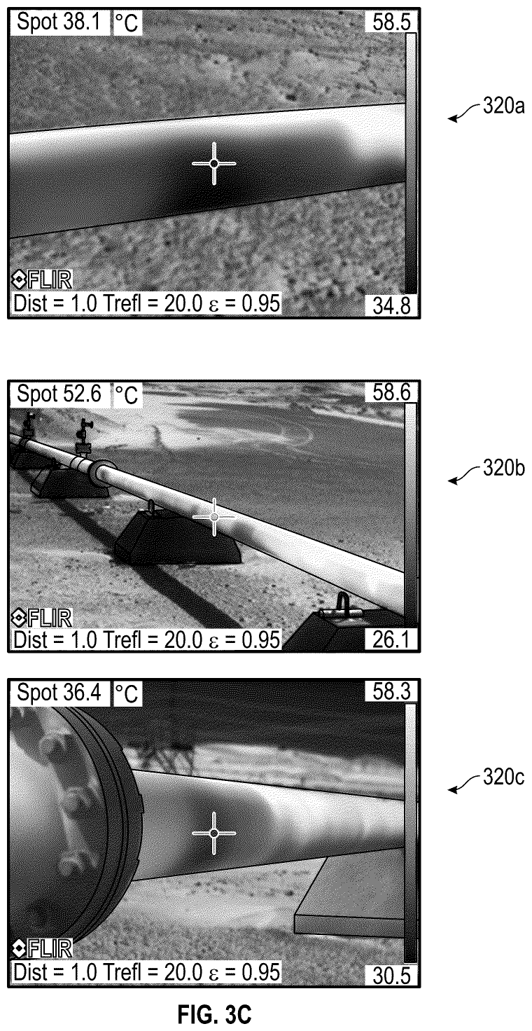

FIGS. 3A-3C shows examples in accordance with one or more embodiments. The examples shown in FIGS. 3A-3C may be based on the system and method flowchart described in reference to FIGS. 1A-1B and 2 above. In one or more embodiments, one or more of the modules and/or elements shown in FIGS. 3A-3C may be omitted, repeated, and/or substituted. Accordingly, embodiments of the invention should not be considered limited to the specific arrangements of modules and/or elements shown in FIGS. 3A-3C.

Throughout FIGS. 3A-3C, brightness variations exhibited by the pipeline thermal images correspond to temperature variations across pipeline surface area during the aforementioned transient time period. In other words, the brightness variations indicate that at least some pipeline surface locations but not all of the pipeline surface area have risen to within a pre-determined range of the operating surface temperature of the pipeline, e.g., within 2 degrees of 58 degrees Celsius.

FIG. 3A shows a photograph (300) of tubulars for constructing a pipeline and a thermal camera image (300a) of an example section of the pipeline network (170) depicted in FIG. 1A above. The tubulars shown in the photograph (300) are terminated in flanges for connecting into the pipeline network (170) depicted in FIG. 1A above. The thermal camera image (300a) is captured during a transient time period after the pipeline network (170) becomes on-stream but before it reaches thermal equilibrium with the fluid stream at the elevated temperature. In the thermal camera image (300a), a large portion (300b) of the pipeline exhibits a dark color corresponding to approximately 38.1 degrees Celsius while remaining portion (300c) of the pipeline exhibits a bright color corresponding to approximately 58.5 degrees Celsius. Because the temperature difference exceeds the pre-determined value of 20 degrees Celsius, the pipeline is determined as severely scaled. In fact, the dark large portion (300b) appears to substantially block any fluid flow through the pipeline.

FIG. 3B shows thermal camera images (310a), (310b), and (310c) of example sections of the pipeline network (170) depicted in FIG. 1A above. By scanning pipelines surface temperature during the transient time period, scale location identification is become possible and fast compared to conventional cutting and exploration method. The thermal camera images shown in FIG. 3B are all captured during a transient time period after the pipeline network (170) becomes on-stream but before it reaches thermal equilibrium with the fluid stream at the elevated temperature. In the thermal camera image (310a), the cross hair marking at the center of the image corresponds to the temperature reading 57.8 degrees Celsius and indicates a scale-free area. In the thermal camera image (310b), the cross hair marking at the center of the image corresponds to the temperature reading 53.8 degrees Celsius and indicates a boundary between a scale-free area (311b) and a scaled area (312b). In the thermal camera image (310c), the cross hair marking at the center of the image corresponds to the temperature reading 39.8 degrees Celsius and indicates a scaled area.

FIG. 3C shows thermal camera images (320a), (320b), and (320c) of example sections of the pipeline network (170) depicted in FIG. 1A above. Similar to the thermal camera images depicted in FIG. 3B above, by scanning pipelines surface temperature during the transient time period, scale location identification is become possible and fast compared to conventional cutting and exploration method. The thermal camera images shown in FIG. 3C are also captured during a transient time period after the pipeline network (170) becomes on-stream but before it reaches thermal equilibrium with the fluid stream at the elevated temperature. In the thermal camera image (320a), the cross hair marking at the center of the image corresponds to the temperature reading 38.1 degrees Celsius and indicates a scaled area. In the thermal camera image (330b), the cross hair marking at the center of the image corresponds to the temperature reading 52.6 degrees Celsius and indicates a scale-free area. In the thermal camera image (320c), the cross hair marking at the center of the image corresponds to the temperature reading 36.4 degrees Celsius and indicates a scaled area.

Embodiments described above for scale location identification the in the pipeline have the following advantages: (i) high accuracy along pipelines in the actual field with very low cost compare to the conventional scale location exploration methods, (ii) faster in identifying scale location and can be used as non-intrusive inspection to insure pipelines are free of scale, and (iii) minimum efforts required, only scanning pipeline and no need for multiple cuts of the pipeline.

While the invention has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A method for detecting a scaled area of a pipeline in an oil and gas facility, comprising:
scanning, using a thermal camera, a surface area of the pipeline in an offline status to determine that surface temperature across the surface area is within a pre-determined range of ambient temperature;
starting up fluid flow of the pipeline upon determination that the surface temperature across the surface area is within the pre-determined range of the ambient temperature;
further scanning, using the thermal camera and subsequent to starting up the fluid flow, the surface area of the pipeline to determine that at least one location of the surface area, and not an entirety of the surface area, is within a pre-determined range of an operating surface temperature of the pipeline;
detecting, in response to the further scanning, a low temperature portion of the surface area; and
classifying the lower temperature portion of the surface area as a scaled area.

2. The method according to claim 1, further comprising:
facilitating, based on the classified scaled area, a restoration operation of the pipeline in the oil and gas facility.

3. The method according to claim 2, wherein the restoration operation comprises replacing or retrofitting a portion of the pipeline encompassing the scaled area.

4. The method according to claim 2, wherein the restoration operation comprises a descaling operation of a portion of the pipeline encompassing the scaled area.

5. The method according to claim 1, further comprising:
generating, in response to said further scanning, a surface temperature map of the pipeline,
wherein the low temperature portion corresponds to a surface temperature range in the surface temperature map that is lower than the operating surface temperature by at least a pre-determined threshold.

6. The method according to claim 5, further comprising:
generating, using a pre-determined algorithm and based on the surface temperature range of the scaled area, an estimated scale thickness of the scaled area; and
performing, in response to the estimated scale thickness exceeding a pre-determined scale thickness threshold, the restoration operation of the pipeline.

7. The method according to claim 6,
wherein the pre-determined scale thickness threshold is a pre-determined percentage of an inside diameter of the pipeline.

8. The method according to claim 6, further comprising:
determining, based on a physical inspection, an actual scale thickness of the scaled area;
comparing the estimated scale thickness and the actual scale thickness to generate a calibration result; and
adjusting the pre-determined algorithm based on the calibration result.

9. The method according to claim 8, further comprising:
collecting a plurality of calibration results based on a plurality of detected scaled areas of the pipeline; and
further adjusting the pre-determined algorithm based on the plurality of calibration results.

10. The method according to claim 9, further comprising:
storing, by a data gathering and analysis system, the plurality of calibration results as a machine learning data set,
wherein said further adjusting the pre-determined algorithm based on the plurality of calibration results is performed by the data gathering and analysis system using a machine learning technique based on the machine learning data set.

11. A system for detecting a scaled area of a pipeline in an oil and gas facility, comprising:
a thermal camera configured to:
scan a surface area of the pipeline in an offline status to determine a surface temperature across the surface area is within a pre-determined range of ambient temperature, wherein fluid flow of the pipeline is started up subsequent to the determination; and
further scan, subsequent to starting up the fluid flow, the surface area of the pipeline to determine that at least one location of the surface area, and not an entirety of the surface area, is within a pre-determined range of an operating surface temperature of the pipeline; and
a data gathering and analysis system configured to detect, in response to said further scanning, a low temperature portion of the surface area as a scaled area.

12. The system according to claim 11, the data gathering and analysis system being further configured to:
facilitate, based on the detected scaled area, a restoration operation of the pipeline in the oil and gas facility.

13. The system according to claim 12, wherein the restoration operation comprises replacing or retrofitting a portion of the pipeline encompassing the scaled area.

14. The system according to claim 12, wherein the restoration operation comprises a descaling operation of a portion of the pipeline encompassing the scaled area.

15. The system according to claim 11, the data gathering and analysis system being further configured to:
generate, in response to said further scanning, a surface temperature map of the pipeline,
wherein the low temperature portion corresponds to a surface temperature range in the surface temperature map that is lower than the operating surface temperature by at least a pre-determined threshold.

16. The system according to claim 15, the data gathering and analysis system further configured to:
generate, using a pre-determined algorithm and based on the surface temperature range of the scaled area, an estimated scale thickness of the scaled area,
wherein the restoration operation of the pipeline is performed in response to the estimated scale thickness exceeding a pre-determined scale thickness threshold.

17. The system according to claim 16,
wherein the pre-determined scale thickness threshold is a pre-determined percentage of an inside diameter of the pipeline.

18. The system according to claim 16, the data gathering and analysis system further configured to:
obtain, based on a physical inspection, an actual scale thickness of the scaled area;
compare the estimated scale thickness and the actual scale thickness to generate a calibration result; and
adjust the pre-determined algorithm based on the calibration result.

19. The system according to claim 18, the data gathering and analysis system being configured to:
collect a plurality of calibration results based on a plurality of detected scaled areas of the pipeline; and
further adjust the pre-determined algorithm based on the plurality of calibration results.

20. The system according to claim 19, the data gathering and analysis system being configured to:
store the plurality of calibration results as a machine learning data set; and
wherein said further adjusting the pre-determined algorithm based on the plurality of calibration results is performed using a machine learning technique based on the machine learning data set.
